(19) United States
(12) Patent Application Publication
(10) Pub. No.: US 2018/0083299 A1
(43) Pub. Date: Mar. 22, 2018

(54) FUEL CELL DRIVING METHOD, FUEL CELL SYSTEM, AND VEHICLE

(71) Applicant: Kabushiki Kaisha Toshiba, Minato-ku (JP)

(72) Inventors: Wu MEI, Yokohama (JP); Taishi FUKAZAWA, Meguro (JP); Yuta KANAI, Fuchu (JP)

(73) Assignee: Kabushiki Kaisha Toshiba, Minato-ku (JP)

(21) Appl. No.: 15/439,523

(22) Filed: Feb. 22, 2017

(30) Foreign Application Priority Data
Sep. 21, 2016 (JP) 2016-184901

(51) Int. Cl. H01M 8/04858

(52) U.S. Cl. CPC H01M 8/04865; H01M 2250/20

(57) ABSTRACT

A fuel cell driving method of an embodiment includes applying a voltage with a potential cycle including repetitions of low potential and high potential by use of a power supply connected to an anode and a cathode of a membrane electrode assembly having the anode, an electrolyte membrane, and the cathode. The low potential is 0.85 V or less for the cathode with reference to a potential of the anode. The high potential is 1.10 V or more for the cathode with reference to a potential of the anode.

### CROSS-REFERENCE TO RELATED APPLICATION

This application is based upon and claims the benefit of priority from Japanese Patent Application No. 2016-184901, filed on Sep. 21, 2016; the entire contents of which a re incorporated herein by reference.

### FIELD

Embodiments described herein relate to a solar cell, a multi-junction solar cell, a solar cell module, and a solar power system.

### BACKGROUND

In recent years, an electrochemical cell has been actively studied. A fuel cell among electrochemical cells includes a system for generating power by electrochemically reacting a fuel such as hydrogen and an oxidizer such as oxygen. In particular, a polymer electrolyte membrane fuel cell (PEFC) has been put into practical use as household stationary power supply or automotive power supply because of its low loads on the environments. A catalyst layer included in each electrode of PEFC typically employs a carbon-supported catalyst supporting a catalyst material on a carbon black carrier. A carbon carrier erodes due to power generation of a fuel cell, a deterioration in catalyst layer and membrane electrode assembly (MEA) including the catalyst layer is large, and a large amount of catalyst is used for securing durability of the fuel cell. One great object for wide use of PEFC is to reduce cost by a reduction in use of noble-metal catalyst.

In order to avoid a deterioration in catalyst due to a carbon carrier and to enhance catalyst activity and electrochemical cell property, there is proposed a carrier-less noble-metal porous catalyst layer or a catalyst layer including nano-sheet noble metal, thereby securing excellent durability and high property even by a small amount of platinum. However, a property of the fuel cell using the catalyst layer is sensitive to contamination during a manufacture process or in use (for example, an average concentration (in volume) of impurities in the air is 18 ppb of sulfur oxide and 46 ppb of nitrogen oxide), and a deterioration in property of the fuel cell is problematic.

### BRIEF DESCRIPTION OF THE DRAWINGS

FIG. 1 is a schematic diagram of a fuel cell system according to an embodiment;

FIGS. 2A to 2C are SEM images of a catalyst layer including a sheet-shaped noble-metal catalyst according to the embodiment;

FIG. 3 is a flowchart of a driving method according to the embodiment; and

FIG. 4 is a schematic diagram of a vehicle according to the embodiment.

### DETAILED DESCRIPTION

A fuel cell driving method of an embodiment includes applying a voltage with a potential cycle including repetitions of low potential and high potential by use of a power supply connected to an anode and a cathode of a membrane electrode assembly having the anode, an electrolyte membrane, and the cathode. The low potential is 0.85 V or less for the cathode with reference to a potential of the anode. The high potential is 1.10 V or more for the cathode with reference to a potential of the anode.

An embodiment of the present disclosure will be described below in detail with reference to the drawings.

### First Embodiment

A first embodiment is for a fuel cell driving method and a fuel cell system for performing the fuel cell driving method. The fuel cell driving method according to the embodiment has a driving step with a potential cycle including repetitions of low potential and high potential by use of a power supply connected to an anode and a cathode of a membrane electrode assembly having the anode, an electrolyte membrane, and the cathode, in which the low potential is 0.85 V or less for the cathode with reference to a potential of the anode and the high potential is 1.10 V or more for the cathode with reference to a potential of the anode. The fuel cell system according to the embodiment has an anode, a cathode, and an electrolyte membrane, connects a membrane electrode assembly supplied with fuel and oxidizer for power generation to the anode and the cathode, and has a power supply for applying a voltage with a potential cycle between the anode and the cathode. A power supply is controlled by a control unit. The control unit of the fuel cell system applies a potential by a fuel cell driving method according to an embodiment.

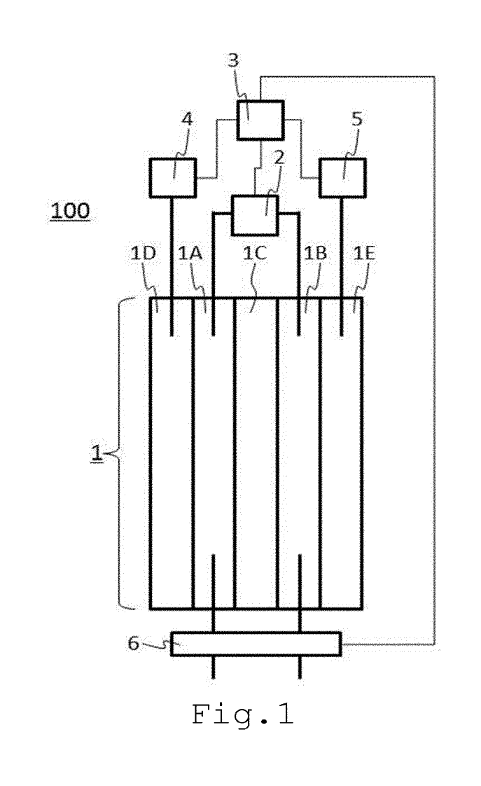

FIG. 1 is a schematic diagram of a fuel cell system 100 according to the first embodiment. The fuel cell system 100 includes a membrane electrode assembly 1, a power supply 2 electrically connected to the membrane electrode assembly 1, a control unit 3 configured to control the power supply 2, a fuel supply unit 4, an oxidizer supply unit 5, and a load control unit 6.

(Membrane Electrode Assembly)

The membrane electrode assembly 1 includes an anode 1A, a cathode 1B, and an electrolyte membrane 1C arranged therebetween. Further, the membrane electrode assembly 1 includes a first diffusion layer 1D as diffusion layer of the anode 1A and a second diffusion layer 1E as diffusion layer of the cathode 1B.

The anode 1A and the cathode 1B have a catalyst layer including noble-metal elements. The catalyst layer is provided on the first diffusion layer 1D or the second diffusion layer 1E. The catalyst layer is arranged between the electrolyte membrane 1C and the first diffusion layer 1D or the second diffusion layer 1E. The first diffusion layer 1D and the second diffusion layer 1E function as substrates of the catalyst layer.

The electrolyte membrane 1C preferably has proton conductivity. An electrolyte membrane having proton conductivity can employ fluorine resin having a sulfonic group (such as Nafion (Du Pont), Flemion (Asahi Kasei Corporation), and Asibrec (Asahi Glass Co., Ltd.)), or inorganic substance such as tungsten acid or phosphotungstic acid.

A conductive porous sheet is suitable for the first diffusion layer 1D and the second diffusion layer 1E (substrates of the catalyst layer). The conductive porous sheet may employ a sheet made of an air-permeable or liquid-permeable material such as carbon cloth or carbon paper.

The anode 1A is supplied with one or more fuels among hydrogen, methanol, ethanol, and formic acid. The fuel is controlled in its supply to the anode 1A by the fuel supply unit 4 connected to the first diffusion layer 1D. The cathode 1B is supplied with an oxidizer such as air or oxygen (high-purity oxygen). The oxidizer is controlled in its supply to the cathode 1B by the oxidizer supply unit 5 connected to the second diffusion layer 1E.

The catalyst layer preferably includes a noble-metal element in terms of high-power fuel cell property. The catalyst layer preferably contains at least one of the group of noble-metal elements such as Pt, Ru, Rh, Os, Ir, Pd and Au. More specifically, a porous catalyst layer including a noble-metal porous material or a sheet-shaped noble metal is preferable. The porous catalyst layer is a carrier-less catalyst layer which is not supported on a carrier and is made of a noble-metal porous material or sheet-shaped noble metal. The porous catalyst layer is configured of a unit having a porous configuration or a laminated configuration in which gap layers are present between a plurality of layers of sheet-shaped noble metal. Even by use of a small amount of noble-metal catalyst, high property and high durability of the membrane electrode assembly can be secured.

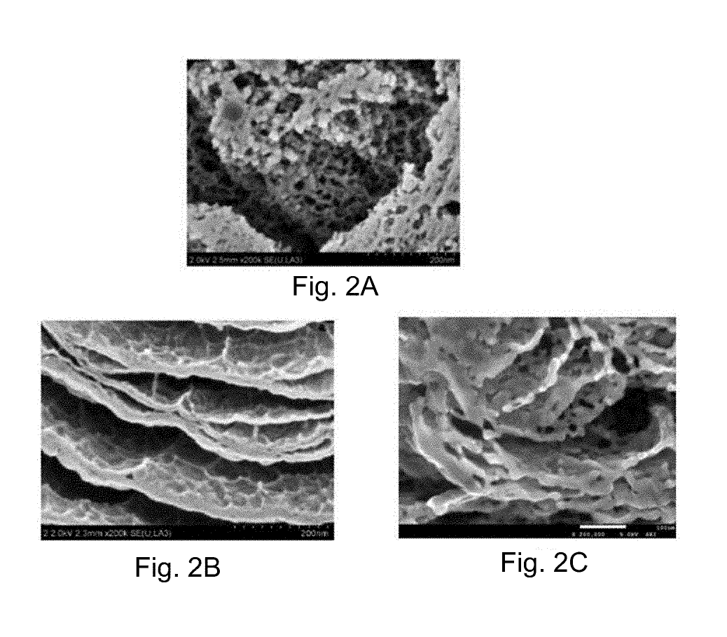

FIG. 2A illustrates a scanning electron microscope (SEM) image of a unit having a porous configuration. FIGS. 2B and 2C illustrate SEM images of a unit having a laminated configuration including a plurality of layers of sheet-shaped noble metal and gap layers. In the laminated configuration including gap layers, it is desirable that adjacent nano-sheets are partially integrated with each other. If a nano-ceramic material layer is introduced into the laminated configuration or a porous nano-carbon layer including fiber carbon is arranged between adjacent nano-sheets or material layers, durability and robust property can be further enhanced.

The porous catalyst layer contains any one of metals containing at least one metal of the group of noble-metal elements such as Pt, Ru, Rh, Os, Ir, Pd and Au, alloys, and metal oxides. The porous catalyst layer preferably contains at least Pt, and more preferably contains at least one metal of the group of noble-metal elements such as Ru, Rh, Os, Ir, Pd and Au, and Pt. Such catalyst materials are excellent in catalyst activity, conductivity, and stability. The above metals can be used as oxides, and may be composite oxide containing two or more metals, or mixed oxide. An optimum noble-metal element can be selected as needed depending on a reaction using the membrane electrode assembly. For example, when the cathode of the fuel cell performs an oxidation-reduction reaction, a catalyst having a composition of Pt_{U}M_{1-U} is desirable. Herein, u is at 0<u≤0.9, and the element M is at least one of the group of Co, Ni, Fe, Mn, Ta, W, Hf, Si, Mo, Ti, Zr, Nb, V, Cr, Al and Sn. The catalyst contains Pt between 0 atomic % and 90 atomic %, and an element M between 10 atomic % and 100 atomic %. When the anode of the fuel cell performs a hydrogen-oxidization reaction, a catalyst having a composition of Pt_{V}M_{1-V} is desirable. Herein, v is at 1<v≤0.6, and the element M is at least one of the group of Co, Ni, Fe, Mn, Ta, W, Hf, Si, Mo, Ti, Zr, Nb, V, Cr, Al and Sn. The element M may be one element or a combination of two or more elements.

(Power Supply)

The power supply 2 is a unit connected to the anode 1A and the cathode 1B and directed for applying a voltage having a potential cycle therebetween. The power supply 2 is configured in a combination of a battery (secondary cell) or motor and an inverter circuit or converter circuit. The inverter circuit or converter circuit converts power from the battery or motor into a waveform having a potential cycle. A voltage applied by the power supply 2 to the anode 1A and the cathode 1B is controlled by the control unit 3. The potential cycle will be described below.

(Control Unit)

The control unit 3 is connected to the power supply 2, and controls output from the power supply 2. More specifically, the control unit 3 controls the inverter circuit or converter circuit of the power supply 2 thereby to convert power supplied from the power supply into a waveform having a potential cycle. The control unit 3 is under software control or hardware control. The control unit 3 has an integrated circuit such as microcontroller or System on Chip (SoC), and can control the power supply 2 by use of the integrated circuit. Further, as another form, the control unit 3 may have a computer and may control the power supply 2 by use of the computer. The control unit 3 is connected to the fuel supply unit 4, the oxidizer supply unit 5, and the load control unit 6 in addition to the power supply 2, and may control them. The potential cycle will be described below.

(Fuel Supply Unit)

The fuel supply unit 4 is connected to the first diffusion layer 1D, and supplies the anode 1A with a fuel via the first diffusion layer 1D. The fuel supply unit 4 can adjust the amount of supplied fuel to the anode 1A by controlling a pump or blower and a valve. The fuel supply unit 4 is preferably controlled in the amount of supplied fuel under control of the control unit 3.

(Oxidizer Supply Unit)

The oxidizer supply unit 5 is connected to the second diffusion layer 1E, and supplies the cathode 1B with an oxidizer via the second diffusion layer 1E. The oxidizer supply unit 5 can adjust the amount of supplied oxidizer to the cathode 1B by controlling a pump or blower and a valve. The oxidizer supply unit 5 is preferably controlled in the amount of supplied oxidizer under control of the control unit 3.

(Load Control Unit)

The load control unit 6 is present between the membrane electrode assembly 1 and a load (not illustrated). A terminal connected to the load is illustrated in the Figure. The load control unit 6 preferably includes an inverter circuit configured to convert power generated by the membrane electrode assembly 1. The load control unit 6 is connected to the control unit 3 and controls power supply to the load.

(Driving Method)

A fuel cell driving method according to the embodiment will be described below. The driving method is directed for performing a processing of cleaning or aging (activating) the catalyst layer. The driving method for performing a function recovery or aging (activation) processing has a driving step of applying a voltage having a potential cycle by use of the power supply connected to the anode 1A and the cathode 1B.

The potential cycle includes repetitions of low potential and high potential. A voltage having the potential cycle is applied between the anode 1A and the cathode 1B with reference to a potential of the anode. When a voltage having the potential cycle is applied, a fuel such as hydrogen is preferably present in the anode 1A. The potential cycle includes low potential and high potential, and preferably ranges over low potential and high potential. An impurity such as polymer is absorbed on the catalyst layer during the fuel cell power generation driving, or an impurity contamination is caused during a catalyst layer creation process. The catalyst surface is covered with the impurity and the catalyst activity is deteriorated. The impurity in the catalyst layer is removed in the processing of cleaning or aging (activating) the catalyst layer thereby to recover and enhance the property of the membrane electrode assembly 1.

The low potential in the potential cycle is 0.85 V or less, and the high potential is 1.1 V or more. The processing of cleaning or aging the catalyst layer is performed in the potential cycle including repetitions of the low potential and the high potential.

The low potential is preferably between −0.10 V and 0.85 V. When the low potential exceeds 0.85 V, the potential is so high that the cleaning effect and the high property recovery are not insufficient in the low potential state. Further, hydrogen generation is remarkably caused at less than −0.10 V, and thus hydrogen gas can be leaked from the electrode to the outside. The low potential is more preferably between 0.05 V and 0.75 V in the same point of view. The low potential is a noble-metal reduction potential, and an impurity is assumed to be reduced at the potential.

The high potential is preferably between 1.10 V and 1.45 V. When the high potential is less than 1.10 V, the potential is so low that the cleaning effect and the high property recovery are insufficient in the high potential state. A noble metal is remarkably eluted at 1.45 V or more, and it is not preferable that a deterioration in property can be caused. The high potential is more preferably between 1.15 V and 1.35 V in the same point of view. The high potential is a noble-metal elution potential, and an impurity is assumed to be oxidized at the potential.

The number of times of the potential cycle is preferably 3 to 500 times. It is more preferably 5 to 200 times. The cleaning effect and the high property recovery are insufficient at less than three times of the potential cycle. The cleaning effect and the high property recovery are enough at 5 times or more of the potential cycle. The system driving method is not efficient and is less practical at more than 500 times of the potential cycle. The number of times of the potential cycle is preferably 200 times or more in the same point of view.

Also when the processing is performed at either the high potential or the low potential, the cleaning effect and the high property recovery are insufficient. When the processing is performed at either the high potential or the low potential, the cleaning effect and the high property recovery are ⅕ or less than the processing is performed in the potential cycle of repetitions of high potential and low potential. The reduction processing and the oxidation processing are repeatedly performed thereby to achieve the high cleaning effect and the high property recovery.

A time at the low potential in one cycle of the potential cycle, or a time at −0.10 V to 0.85 V in one cycle of the potential cycle is preferably between 0.05 seconds and 100 seconds. The reduction effect is less due to the low potential for less than 0.05 seconds. When the reduction time exceeds 100 seconds, the reduction processing effect is not great and the processing time is longer. The time is preferably between 0.2 seconds and 100 seconds in the same point of view. At the low potential, a more effective processing time is caused depending on a magnitude of the low potential. A more effective processing time at each potential preferably meets any of the followings. A time at −0.10 V to 0.05 V in one cycle of the potential cycle is preferably between 0.2 seconds and 3 seconds. A time at more than 0.05 V to 0.5 V in one cycle of the potential cycle is preferably between one second and 10 seconds. A time at more than 0.5 V to 0.75 V in one cycle of the potential cycle is preferably between 3 seconds and 100 seconds. A time at more than 0.5 V to 0.85 V in one cycle of the potential cycle is preferably between 3 seconds and 100 seconds.

A time at the high potential in one cycle of the potential cycle, or a time at 1.10 V to 1.35 V in one cycle of the potential cycle is preferably between 0.1 seconds and 30 seconds. The oxidization effect is less due to the high potential for less than 0.1 seconds. When the oxidization time exceeds 30 seconds, the impurity is removed, but it is not preferable that the amount of eluted catalyst is larger. The time is preferably between 1 second and 10 seconds in the same point of view. A more effective processing time is caused depending on a magnitude of the high potential. A more effective processing time per potential preferably meets any of the followings. A time at 1.10 V to 1.35 V in one cycle of the potential cycle is preferably between 1 second and 30 seconds. A time at more than 1.35 V to 1.45 V in one cycle of the potential cycle is preferably between 0.1 seconds and 10 seconds.

A waveform of the potential cycle is not particularly limited to rectangular wave, triangle wave, sine wave, and the like. The cleaning effect can be achieved even by shortening the potential keeping time at the upper and lower limit potentials (zero at maximum) and adjusting a sweep rate between the lower limit potential and the upper limit potential. The sweep rate is preferably 0.5 V/second or less.

The operation of the embodiment on a nanoparticle-shaped noble metal can cause a large amount of flown noble metal, but the noble metal can be almost prevented from flowing out in a noble-metal porous material or a porous catalyst layer including a noble-metal porous material or sheet-shaped noble metal. The detailed mechanism has not been completely revealed, but it is estimated that the surface configuration of a nano-sheet noble-metal catalyst and the configuration of a noble-metal catalyst layer made of a noble-metal porous material or nano-sheet noble metal largely prevent a noble metal from flowing out in the potential cycle.

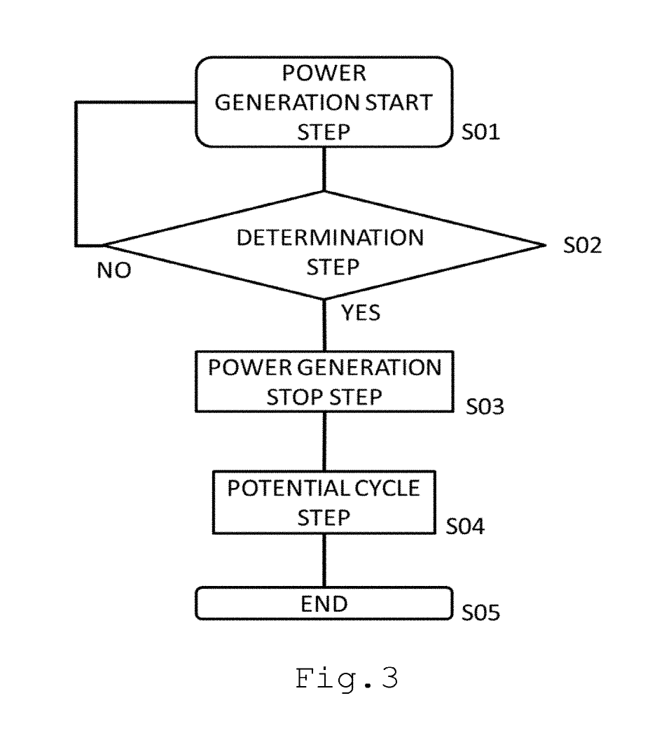

FIG. 3 is a flowchart of the fuel cell driving method according to the embodiment. The flowchart of FIG. 3 illustrates a power generation start step S01, a determination step S02, a power generation stop step S03, a potential cycle step S04, and end S05.

The power generation start step S01 is a step of starting power generation in the membrane electrode assembly 1 by controlling the fuel supply unit 4 and the oxidizer supply unit 5 to supply a fuel and an oxidizer to the anode 1A and the cathode 1B, respectively.

The determination step S02 is a step of determining whether to drive the potential cycle step S04. A plurality of determination references are present, and the potential cycle step S04 is performed when one or more conditions set in the determination references are met. The determination references are reduction in power generation potential, total time of power generation, abnormal power generation, and the like, for example. When the potential cycle step S04 does not need to be performed as a result of the determination in the determination step S02, it is preferable that power generation is kept until the power generation is stopped under any control, and the determination step S02 is performed again after a required time elapses.

The power generation stop step S03 is a step of stopping power generation by the membrane electrode assembly. When it is determined that the potential cycle step S04 is to be performed during power generation by the membrane electrode assembly 1, it is preferable to perform a step of controlling the load control unit 6 and electrically interrupting the load from the membrane electrode assembly 1 before the potential cycle step S04. Further, it is preferable that the oxidizer supply unit 5 is controlled to perform a step of reducing a flow rate of the oxidizer supplied to the cathode 1B or stopping supplying the same. Further, it is preferable that the fuel supply unit 4 is controlled to perform a step of reducing a flow rate of the fuel supplied to the anode 1A or stopping supplying the same. Power generation by the membrane electrode assembly 1 is stopped in any step of the above. It is more preferable to reduce or stop supplying the oxidizer.

The potential cycle step S04 is a step of performing a function recovery or aging (activation) processing, or specifically a driving step of applying a voltage with a potential cycle by use of the power supply connected to the anode 1A and the cathode 1B. The potential cycle step S04 may be performed before the start of the power generation driving. The potential cycle step S04 is preferably performed alone for the aging processing irrespective of the flowchart. In the potential cycle step S04, the power supply 2 is operated to start the potential cycle driving, and the potential cycle driving is stopped when the operation of the power supply 2 is stopped. Further, the potential cycle step S04 may be performed alone in response to an instruction of the operator. The driving of the fuel cell system ends (S05) after the potential cycle step S04.

It is desirable to add an operation procedure of searching an abnormal reduction in power generation property before the operations of the embodiment when the fuel cell system is used. For example, the embodiment is operated on the basis of accumulated data when the reduction is faster than the typical property reduction speed. It is preferable to interrupt the load and to reduce or stop a flow rate of the oxidizer supplied to the cathode. The operation method according to the embodiment can be used as a fuel cell aging processing. In this case, the operation method is performed in combination with other operation method such as high current density power generation thereby to perform aging in a shorter time.

### Second Embodiment

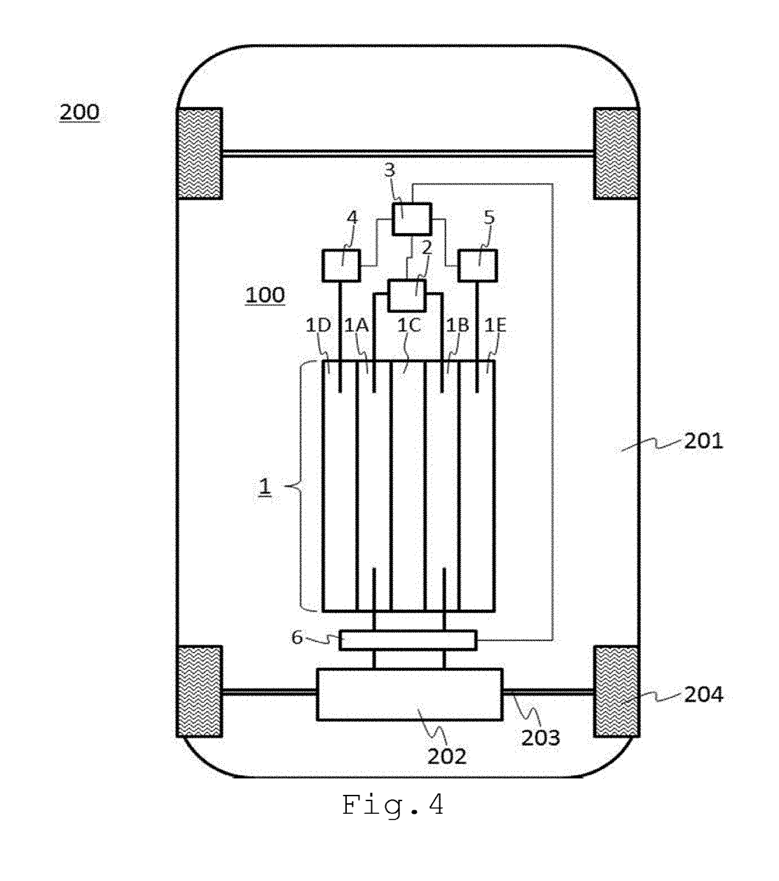

A second embodiment is for a vehicle having the fuel cell system 100 according to the first embodiment. FIG. 4 is a schematic diagram of a vehicle 200 according to the embodiment. The vehicle illustrated in the schematic diagram of FIG. 4 includes the fuel cell system 100, a vehicle body 201, a motor 202, axles 203, and wheels 204. The anode 1A and the cathode 1B in the fuel cell system are connected to the motor 202 as load via the load control unit 6. The motor rotates the axles 203 connected to the wheels 204 thereby to rotate the wheels.

It is preferable to perform the driving step of applying a voltage with a potential cycle by use of the power supply connected to the anode 1A and the cathode 1B in the fuel cell system 100 according to the first embodiment in the vehicle 200. The driving enables the operation performance of the vehicle to be enhanced or recovered. It is preferable to control such that the potential cycle step is automatically performed, thereby automatically recovering the vehicle performance. The potential cycle step is preferably performed before the start of the fuel cell power generation after the vehicle 200 is activated, or after the end of the fuel cell power generation after the vehicle 200 is stopped.

Examples and Comparative examples will be described below.

### Example 1

<Manufacture of Electrode Having Carrier-Less Catalyst Layer and Membrane Electrode Assembly>

A carbon paper Toray 060 (Toray Industries, Inc.) having a carbon layer with a thickness of 30 μm is prepared as a substrate. A catalyst layer configured of a unit having a porous configuration is sputtered to be formed on the substrate, thereby obtaining an electrode having a carrier-less porous catalyst layer. The loading densities of Pt catalyst in the anode and the cathode are 0.05 mg/cm² and 0.15 mg/cm², respectively.

A square fragment of 7.07 cm×7.07 cm is cut out from the electrode and is thermally joined with an electrolyte membrane (Nafion 211 (Du Pont, trademark)) thereby to obtain a membrane electrode assembly (the electrode area is about 50 cm²). The resultant membrane electrode assembly is set between two diffusion layers with a flow path therebetween, thereby manufacturing a single cell of high-polymer electrolyte fuel cell.

<Power Generation and Potential Cycle Operation>

The resultant single cell is kept at 70° C., hydrogen as fuel is supplied to the anode, air is supplied to the cathode, and power is generated in two hours to one day at a current density of 1 A/cm² or more, thereby performing the conditioning. Thereafter, power is generated at a current density of 0.8 A/cm². A voltage of V0is recorded after power is generated for 20 hours. Then, air containing 50 ppb of SO₂, 100 ppb of NO₂, 1 ppm of CO, and 1000 ppm of CO₂ is supplied, power is generated at a current density of 0.8 A/cm², and a voltage of V1 after the power generation for 20 hours is recorded. Thereafter, the load is interrupted, various potential cycle operations indicated in Table 1 are performed by use of the power supply connected between the anode and the cathode, and then power is generated at a current density of 0.8 A/cm² again thereby to record a voltage of V2 after the power generation for 20 hours. Example 11 indicates a triangle wave, Example 12 indicates a sine wave, and other Examples and Comparative examples indicate a rectangle wave. A value of (V2−V1)/(V0−V1) is calculated and recorded as property recovery rate. The test is repeatedly made five times, and the average property recovery rates are summarized in Table 1.

TABLE 1

| | Lower limit | Upper limit | | |
|---|---|---|---|---|
| | potential | potential | Application | Application |
| | (V) | (V) | time A | time B |
| Example 1 | 0.5 | 1.2 | 8 | 4 |
| Example 2 | 0.75 | 1.3 | 2.5 | 3 |
| Example 3 | 0.05 | 1.35 | 15 | 15 |
| Example 4 | 0.5 | 1.1 | 3 | 5 |
| Example 5 | 0.1 | 1.4 | 10 | 10 |
| Example 6 | 0.05 | 1.35 | 1 | 2 |
| Example 7 | 0.05 | 1.35 | 10 | 1 |
| Example 8 | 0.05 | 1.35 | 0.5 | 10 |
| Example 9 | 0.05 | 1.35 | 5 | 5 |
| Example 10 | 0.5 | 1.1 | 3 | 1 |
| Example 11 | 0.05 | 1.35 | 3 | 3 |
| Example 12 | 0.05 | 1.35 | 3 | 3 |
| Example 13 | 0.2 | 1.4 | 3 | 20 |
| Example 14 | −0.1 | 1.4 | 0.5 | 3 |
| Example 15 | 0.7 | 1.2 | 3 | 10 |
| Example 16 | 0.8 | 1.2 | 1 | 3 |
| Example 17 | 0.85 | 1.2 | 20 | 3 |
| Example 18 | 0.5 | 1.1 | 3 | 20 |
| Example 19 | −0.1 | 1.35 | 0.1 | 3 |
| Example 20 | 0.5 | 1.45 | 3 | 0.05 |
| Comparative | No | 1.15 | 200 | 0 |
| example 1 | processing | | | |
| Comparative | 0.8 | 1.2 | 2 | 2 |
| example 2 | | | | |
| Comparative | 0.5 | 1.2 | 2 | 2 |
| example 3 | | | | |
| Comparative | 0.5 | 1 | 5 | 5 |
| example 4 | | | | |
| Comparative | 0.5 | 1.5 | 5 | 5 |
| example 5 | | | | |
| Comparative | −0.15 | 1.1 | 5 | 5 |
| example 6 | | | | |
| Comparative | 0.5 | No | 0 | 200 |
| example 7 | | processing | | |

Application time A: Application time s/cycle of potential of
less than 0.75 V
Application time B: Application time s/cycle of potential of
1.1 V or more

| | Number of | Recovery |
|---|---|---|
| | cycles | rate |
| Example 1 | 20 | 100 |
| Example 2 | 200 | 100 |
| Example 3 | 5 | 110 |
| Example 4 | 300 | 90 |
| Example 5 | 3 | 90 |
| Example 6 | 20 | 100 |
| Example 7 | 20 | 100 |
| Example 8 | 20 | 95 |
| Example 9 | 20 | 105 |
| Example 10 | 500 | 90 |
| Example 11 | 50 | 100 |
| Example 12 | 50 | 100 |
| Example 13 | 100 | 80 |
| Example 14 | 50 | 100 |
| Example 15 | 50 | 100 |
| Example 16 | 200 | 80 |
| Example 17 | 50 | 95 |
| Example 18 | 200 | 95 |
| Example 19 | 50 | 100 |
| Example 20 | 50 | 90 |
| Comparative | No cycle | 20 |
| example 1 | | |
| Comparative | 50 | 70 |
| example 2 | | |
| Comparative | 3 | 20 |
| example 3 | | |
| Comparative | 500 | 60 |
| example 4 | | |
| Comparative | 500 | 20 |
| example 5 | | |
| Comparative | 50 | 70 |
| example 6 | | |
| Comparative | No cycle | 0 |
| example 7 | | |

As indicated in Table 1, the operation methods according to Examples 1 to 20 cause a property recovery rate of 80 to 110%. Comparative examples 1 to 7 are deteriorated in recovery rate. Though not indicated in Table, a reduction in Platinum due to the potential cycle operation is rarely confirmed except for Comparative example 5 in the decomposition evaluation of the membrane electrode assembly after five tests. In Comparative example 6, hydrogen is remarkably generated on the cathode side and the voltage lower limit is too low.

According to any one of the embodiments described above, it is possible to provide a fuel cell having a high fuel cell property with a less amount of noble metal according to the driving method of the embodiment.

The embodiments are performed on the processing of aging an anode, and thus a property enhancement effect may be obtained. When the potential cycle according to the embodiments is performed on an anode, hydrogen is supplied to the cathode, and a voltage with a potential cycle is applied between the anode 1A and the cathode 1B with reference to a potential of the cathode.

Here, some elements are expressed only by element symbols thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. A fuel cell driving method comprising
applying a voltage with a potential cycle including repetitions of low potential and high potential by use of a power supply connected to an anode and a cathode of a membrane electrode assembly having the anode, an electrolyte membrane, and the cathode,
wherein the low potential is 0.85 V or less for the cathode with reference to a potential of the anode, and
the high potential is 1.10 V or more for the cathode with reference to a potential of the anode.

2. The method according to claim 1,
wherein the potential cycle is repeatedly performed three times or more.

3. The method according to claim 1,
wherein the low potential is between −0.10 V and 0.85 V for the cathode with reference to a potential of the anode.

4. The method according to claim 1,
wherein the high potential is between 1.10 V and 1.45 V for the cathode with reference to a potential of the anode.

5. The method according to claim 1,
wherein the cathode and the anode have a porous catalyst layer containing a noble-metal porous material or sheet-shaped noble metal.

6. The method according to claim 1,
wherein the cathode and the anode are connected to a load,
the method further comprising interrupting the load before the applying the voltage with the potential cycle.

7. The method according to claim 1, further comprising
reducing or stopping a flow rate of an oxidizer supplied to the cathode before the applying the voltage with the potential cycle.

8. The method according to claim 1,
wherein a time at a low potential in one cycle of the potential cycle is 0.1 seconds or more, and
a time at a high potential in one cycle of the potential cycle is 0.1 seconds or more.

9. The method according to claim 1,
wherein the cathode and the anode contain at least one metal selected from the group of Pt, Ru, Rh, Os, Ir, Pd and Au.

10. The method according to claim 1,
wherein the low potential is between −0.10 V and 0.85 V for the cathode with reference to a potential of the anode, and
a time at a low potential in one cycle of the potential cycle is between 0.05 seconds and 100 seconds.

11. The method according to claim 1,
wherein the high potential is between 1.10 V and 1.35 V for the cathode with reference to a potential of the anode, and
a time at a high potential in one cycle of the potential cycle is between 0.1 seconds and 30 seconds.

12. The method according to claim 1,
wherein a time at −0.10 V to 0.05 V in one cycle of the potential cycle is between 0.2 seconds and 3 seconds,
a time at more than 0.05 V to 0.5 V in one cycle of the potential cycle is between one second and 10 seconds,
a time at more than 0.5 V to 0.75 V in one cycle of the potential cycle is between 3 seconds and 100 seconds, or
a time at more than 0.5 V to 0.85 V in one cycle of the potential cycle is between 3 seconds and 100 seconds

13. The method according to claim 1,
wherein a time at 1.10 V to 1.35 V in one cycle of the potential cycle is between 1 second and 30 seconds, or
a time at more than 1.35 V to 1.45 V in one cycle of the potential cycle is preferably between 0.1 seconds and 10 seconds.

14. The method according to claim 1,
wherein the low potential is between 0.05 V and 0.75 V for the cathode with reference to a potential of the anode.

15. The method according to claim 1,
wherein the high potential is between 1.10 V and 1.35 V for the cathode with reference to a potential of the anode.

16. The method according to claim 1,
wherein the potential cycle is repeatedly performed 3 to 500 times.

17. A fuel cell system comprising:
a membrane electrode assembly;
a power supply connected to the membrane electrode assembly; and
a control unit applying a voltage by the fuel cell driving method according to claim 1.

18. A vehicle comprising the fuel cell system according to claim 17.
